(19) United States
(12) Patent Application Publication
(10) Pub. No.: US 2012/0144867 A1
(43) Pub. Date: Jun. 14, 2012

(54) SYSTEM AND METHOD FOR PRODUCING PATTERNED HEAT-STRENGTHENED GLASS

(75) Inventor: Kelly J. Busch, Waunakee, WI (US)

(73) Assignee: Cardinal FG Company, Eden Prairie, MN (US)

(21) Appl. No.: 13/324,712

(22) Filed: Dec. 13, 2011

Related U.S. Application Data
(60) Provisional application No. 61/422,546, filed on Dec. 13, 2010.

(51) Int. Cl. C03B 23/02; C03B 27/044; C03B 35/16; C03B 27/02

(52) U.S. Cl. 65/104; 65/268

(57) ABSTRACT

This disclosure relates to a method of patterning glass substrate in a glass heat-strengthening line and the resulting patterned heat-strengthened glass. Such patterned heat-strengthened glass substrates are useful, for example, in glass-based solar cells.

### RELATED APPLICATIONS

This application claims the benefit of Provisional Patent Application Ser. No. 61/422,546, titled System and Method for Producing Patterned Heat-Strengthened Glass, filed Dec. 13, 2010, the contents of which are hereby incorporated by reference.

### FIELD OF THE INVENTION

The invention relates to producing patterned heat-strengthened glass in a heat-strengthening line.

### BACKGROUND OF THE INVENTION

Patterns have been provided in glass surfaces to increase the transmittance of the glass and for other purposes. Such patterned glass with increased transmittance is particularly useful in glass-based solar cells. Generally, these patterns have been imparted to glass by one of two methods. First, these patterns have been imparted to a continuous glass ribbon with patterned rollers in a rolled glass process. Second, these patterns have been described as being imparted to a continuous glass ribbon with patterned rollers located immediately downstream of a float bath in a float glass process. In both methods, the pattern is imparted to a hot continuous glass ribbon formed by melting glass-forming ingredients in a continuously operating furnace just downstream of the furnace.

Both methods have a variety of limitations. For example, changing the patterning roller, and associated machine, to form a different pattern or replacing a worn patterning roller leads to waste because it is extremely difficult to interrupt production of the continuous glass ribbon for more than a few minutes. Accordingly, during such roller and/or machine changes, the glass ribbon may continue to pass through the patterning area without patterning, or it may be diverted, cooled, and returned to a furnace. As another example, the pattern in such processes is imparted before the glass ribbon is cut. Cutting patterned glass leads to additional complications, including additional breakage and waste, compared to cutting unpatterned, smooth glass.

### SUMMARY OF THE INVENTION

This disclosure relates to methods of making patterned heat-strengthened (e.g., tempered) glass, and patterned heat-strengthened glasses resulting from these methods. More particularly, this disclosure relates to patterned heat-strengthened glasses where the pattern is imparted in a heat-strengthening (e.g., tempering) line. In such embodiments, glass substrates are heated to a temperature suitable for heat-strengthening, patterned, and then cooled to form a patterned heat-strengthened glass substrate. Such patterned heat-strengthened glass substrates are particularly useful, for example, in glass-based solar cells for both the desirable properties provided by the pattern and for the increased strength provided by the heat-strengthening. Embodiments of the invention also include solar cells having such patterned heat-strengthened glass substrates.

### BRIEF DESCRIPTION OF THE DRAWINGS

FIG. 1A is a top plan view of a planar glass substrate in accordance with an embodiment of the invention.

FIG. 1B is a side plan view of a planar glass substrate in accordance with an embodiment of the invention.

FIG. 2 is a cross-section schematic view of a heat-strengthening line in accordance with an embodiment of the invention.

FIG. 3 is a cross-section schematic view of a patterning zone in accordance with an embodiment of the invention.

FIG. 4 is a cross-section schematic view of a patterning zone in accordance with another embodiment of the invention.

FIG. 5 is a cross-section schematic view of a patterning zone in accordance with another embodiment of the invention.

FIG. 6 is a cross-section schematic view of a patterning zone in accordance with another embodiment of the invention.

FIG. 7 is a cross-section schematic view of a patterning zone in accordance with another embodiment of the invention.

FIG. 8 is side plan schematic view of a furnace, float chamber, and annealing lehr in accordance with an embodiment of the invention.

### DETAILED DESCRIPTION OF PREFERRED EMBODIMENTS

The following detailed description is to be read with reference to the drawings, in which like elements in different drawings have like reference numbers. The drawings, which are not necessarily to scale, depict selected embodiments and are not intended to limit the scope of the invention. Skilled artisans will recognize that the given examples have many alternatives that fall within the scope of the invention. References to above, below, top, bottom, upper, lower and the like will refer to a planar glass substrate oriented in a generally horizontal plane (e.g., as when being conveyed on rollers having a horizontal axis of rotation in a heat-strengthening line).

Embodiments of the invention include a method of patterning glass in a glass heat-strengthening (e.g., tempering) line, the glass heat-strengthening line itself, and the resulting heat-strengthened and patterned glass substrates. Heat-strengthened glass is glass that has been processed by controlled thermal treatments to increase its strength compared to unheat-strengthened or annealed glass. Heat-strengthened glass is made by processes that create high surface compression stress balanced by high internal tensile stress so as to give the glass strength. Because of the stresses, it is stronger than unheat-strengthened glass and will usually shatter into small fragments instead of large shards when broken, making it useful in solar substrate applications and other applications in which both patterning and increased strength are desirable.

In some embodiments, glass is heat-strengthened in a heat-strengthening line, in which the glass is heated in a heating zone and then rapidly cooled in a quenching zone. The various zones of the heat-strengthening line described herein may be different areas of a continuous heat-strengthening line; there may or may not be any physical separation between adjacent zones. This process induces compressive stress in the surfaces of the glass which is balanced by tensile stress in the body of the glass. In some embodiments, the glass heat-strengthening line includes a substrate conveyance system to convey the glass from an inlet end through the heating and quenching zones to a discharge end. In many embodiments, the glass heat-strengthening line is not directly in series with (e.g., is independent of and not located on an assembly line or conveyance line shared with a furnace melting the glass forming ingredients, such as a stand alone line). Accordingly, in these embodiments, the glass fed to the inlet end has cooled to ambient temperature and does not retain heat imparted by melting the glass forming ingredients. Further, in some embodiments, glass fed into the inlet end of the heat-strengthening line is cut glass sized for its intended purpose, rather than a continuous glass ribbon.

In some embodiments, glass is patterned in the heat-strengthening line after it has been heated to a heat-strengthening temperature in a heating zone, and before it is cooled in a quenching zone. Accordingly, in such embodiments, less energy is required to heat the glass to a temperature suitable for patterning the glass because the glass is already at a temperature suitable for heat-strengthening. Further, because the glass is heat-strengthened by rapid cooling in the quenching zone after patterning, a patterned heat-strengthened glass particularly suitable for certain solar cells is achieved. In addition, in many embodiments, patterning rollers can be easily changed without wasting glass as the heat-strengthening line can be shut down or stopped for such work because it is not being feed a continuous glass ribbon. Further, because the glass fed to the heat-strengthening line is generally cut glass, less glass cutting is required after the patterning step, which further reduces waste.

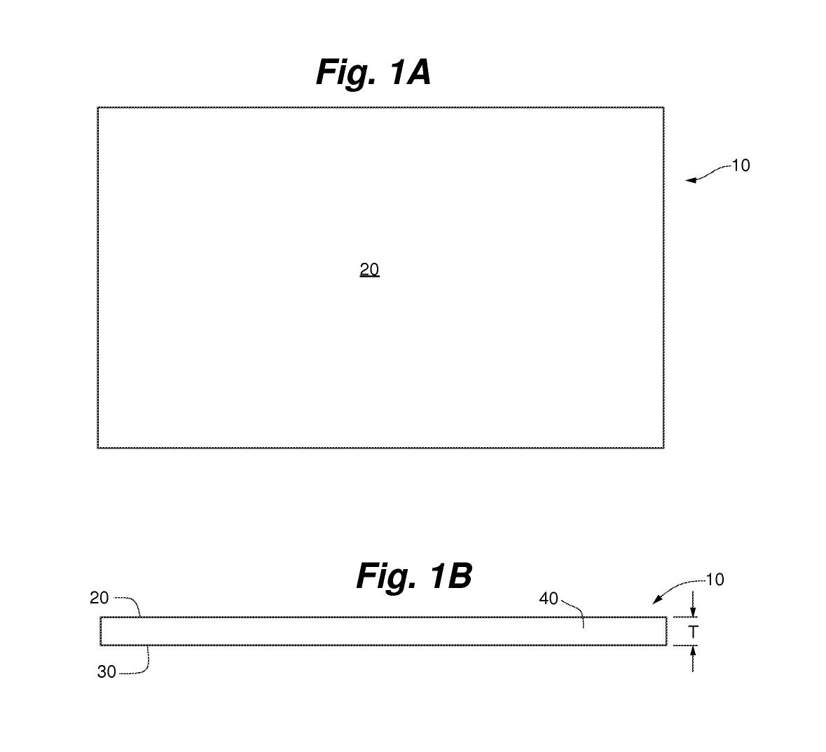

Embodiments of the invention include introducing a planar glass substrate into an inlet end of a heat-strengthening line. As shown in FIGS. 1A-B, the planar glass substrate 10 can have a first major surface 20, a second major surface 30, a thickness T defined by the distance between the first major surface 20 and the second major surface 30, and a perimeter edge 40 extending along the perimeter of the first and second surfaces. The planar glass substrate 10 can be of any desired size, but is generally between 0.5 meter and 3 meters wide, and 1 meter and 4 meters long, within a thickness of between about 1 millimeter and about 15 millimeters (e.g., between about 1.5 millimeters and about 5 millimeters, such as between about 3 millimeters and about 5 millimeters). The planar glass substrate 10 will generally be brittle before it is introduced to the heat-strengthening line (e.g., at room temperature, such as an ambient first temperature generally less than about 100 degrees Celsius throughout its thickness).

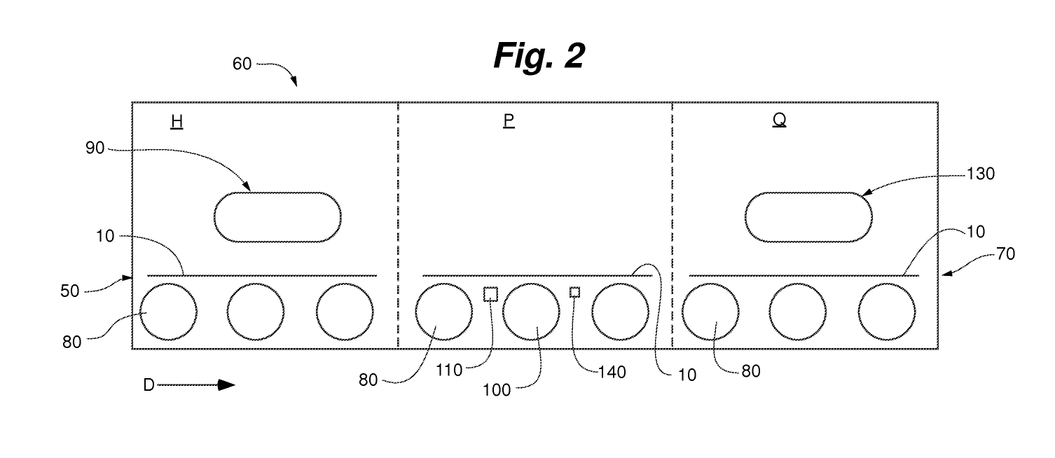

As shown in FIG. 2, embodiments of the invention can also include conveying the planar glass substrate 10 along a direction of travel D from an inlet end 50 of a heat-strengthening line 60 towards a discharge end 70 of the heat-strengthening line on a substrate conveyance system, which may comprise a series of driven conveyance rollers 80. The substrates can be directly conveyed by the conveyance rollers, or the conveyance rollers can drive a belt (not shown) that supports the substrates. Other suitable conveyance apparatuses include combinations of rollers and conveyor belts, palette-drive systems, or the like.

Some embodiments include heating the planar glass substrate 10 in a first heating zone H located between the inlet end and the discharge end of the heat-strengthening line with a heat source 90. In certain embodiments the substrate is heated to a second temperature of between about 550 degrees Celsius and 650 degrees Celsius (e.g., between about 575 and about 600 degrees Celsius) throughout its thickness. Such a temperature is useful for relieving the internal stresses of the glass. The planar glass substrate 10 may be heated by any suitable heat source or method, such as convection type furnaces, radiant furnaces, and hybrid radiant/convection. In one embodiment, the glass is heated to the second temperature via radiant heat from at least one electric heating element disposed in the heating zone. In another embodiment, gas (e.g., air) is heated with a burner, such as an air-fuel burner (e.g., natural gas or propane) and the heated gas is blown into the heating zone to increase the temperature of the glass. In either embodiment, the temperature of the gas (e.g., air) in the heating zone will generally be between about 650 degrees Celsius and about 750 degrees Celsius to heat the planar glass substrate 10 up to the second temperature throughout its thickness. The glass substrates can be heated at a substantially constant rate up to the desired temperature.

In large heating zones, the heating zone may be divided into two or more subzones. In each subzone, the heat source can impart a different amount of heat. Generally, large amounts of heat are imparted towards the inlet end of the heat-strengthening line to raise the glass substrate 10 from the ambient first temperature to the second temperature. As the glass substrate 10 warms as it is conveyed through the heating zone, less heat is required to further heat or maintain the glass substrate 10 at the second temperature.

Some embodiments of the invention include patterning at least one surface 20, 30 of the planar glass substrate 10 in a patterning zone P located downstream of the first heating zone in the direction of substrate travel D. In such embodiments, the surface or surfaces 20, 30 to be patterned are heated with a patterning heat source 110 to a temperature greater than the second temperature, and the heated surface or surfaces of the planar glass substrate 10 are contacted with a patterning roller 100 so as to impart a pattern to the glass substrate 10. Because the glass substrate 10 has already been raised to the second temperature in the heating zone of the heat-strengthening line, substantially less heat is required to sufficiently heat the surface to a temperature at which it can be patterned. In one embodiment, the surface is heated by the patterning heat source 110 to a temperature of between about 750 degrees Celsius and about 900 degrees Celsius (e.g., between about 820 degrees Celsius and about 860 degrees Celsius). In general, this temperature will not be reached throughout the thickness of the glass substrate. Rather, this temperature is reached at the surface and to a depth at or just beyond the depth of the pattern to be imparted. In some embodiments, the viscosity of the surface of the glass is between about 10^{7.6} and about 10⁵ Poise after being heated by the patterning heat source.

The heat can be applied to the surface 20, 30 of the planar glass substrate 10 in a variety of ways. In one embodiment, the patterning heat source 110 includes at least one burner, which is directed toward the at least one surface and is upstream of the patterning roller 100 to heat the surface of the planar glass substrate 10 to the temperature greater than the second temperature. In other embodiments, the patterning heat source 110 includes a series of burners arranged in a line oriented in a cross-conveyance direction to heat the surface along the width of the glass substrate 10. In yet other embodiments, the patterning heat source 110 includes an array of burners, the array having a series of burners oriented in a cross-conveyance direction and a series of burners oriented in a conveyance direction. In other embodiments the patterning heat source includes a microwave emitter, either by itself or in combination with one or more burners.

Any desired pattern can be imparted to the surface 20, 30 with the patterning roller 100. Examples of pattern shapes include repeating prisms, pyramids and/or grooves. Exemplary patterns are disclosed in U.S. Pat. Nos. 6,708,526 and 5,224,978, and US Patent Publication No. 2010/0154,862, the relevant contents of each of which are hereby incorporated by reference. For example, the pattern can be shaped to increase the light transmission of the planar glass substrate 10. Such embodiments are particularly useful for solar cell applications. In some embodiments, the pattern is an anti-reflective pattern. In other embodiments, the pattern is a matte pattern. In certain embodiments, the pattern has a maximum depth of less than 1 millimeter (mm), such as less than 0.5 (e.g., between about 0.01 and 0.1 mm).

The patterning roller 100 is a generally elongated rigid cylinder with an axis of rotation extending in a cross-conveyance direction (e.g., generally transverse to the direction of substrate travel D.) The patterning roller 100 has a suitable diameter (e.g., between about 5 centimeters and about 50 centimeters, e.g., about 30 centimeters). The outer surface of the patterning roller includes features, such as projections and/or reliefs, to impart the desired pattern to the glass substrate.

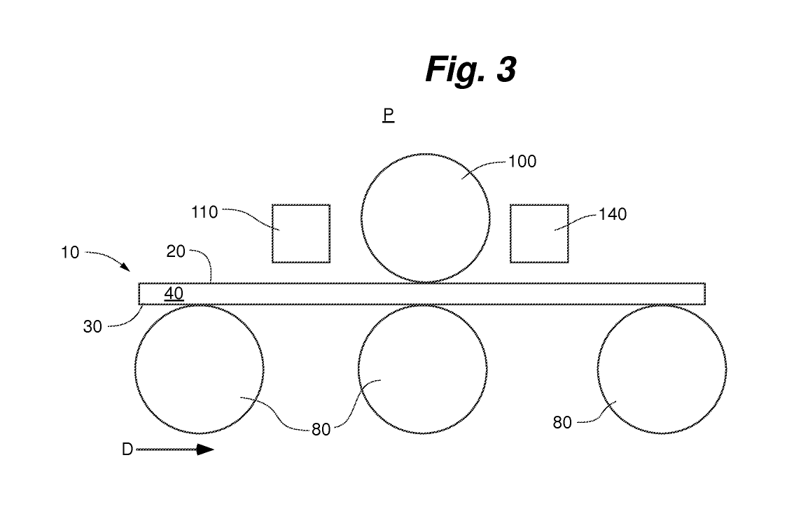

The patterning roller may be placed in a position useful for imparting the desired pattern to the glass substrate. In the embodiment shown in FIG. 3, the patterning zone P includes at least one conveyance roller 80 for conveying the planar glass substrate 10 and a patterning roller 100 positioned above a top surface 20 of the planar glass substrate 10 and vertically aligned with the conveyance roller 80. In such embodiments, the conveyance roller 80 supports the glass substrate 10 and allows the patterning roller 100 to push against the glass substrate 10 with a pressure sufficient to impart the desired pattern. Such embodiments are useful for imparting a pattern to the top surface 20 of the glass substrate 10.

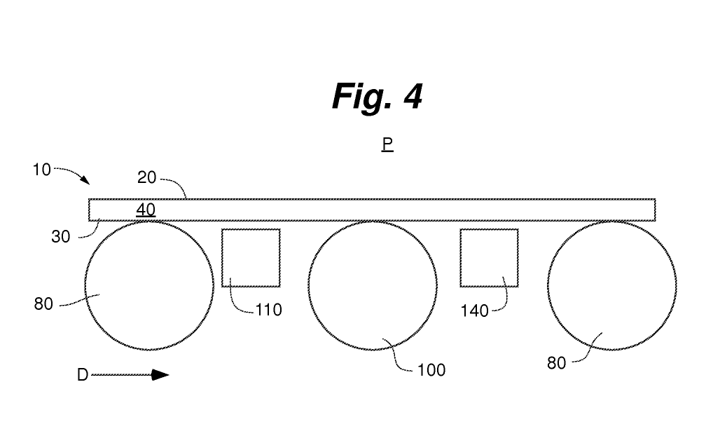

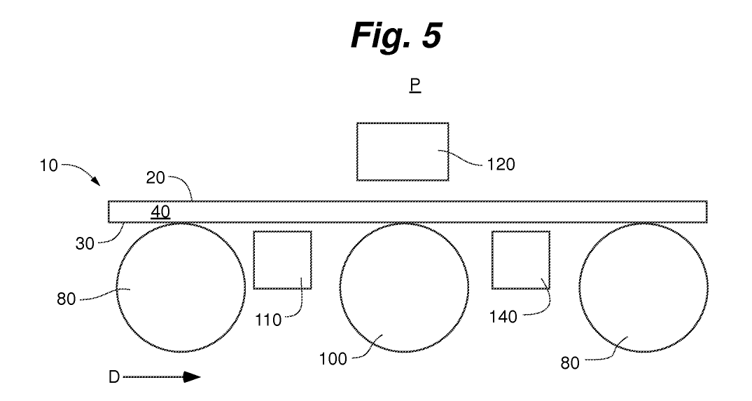

In other embodiments, the patterning roller 100 is positioned on the underside of the glass substrate 10 to impart a pattern to the bottom surface 30 of the glass substrate 10 as it is conveyed through the patterning zone. In some embodiments, the patterning roller 100 replaces a conveyance roller 80. In some embodiments of this type, as shown in FIG. 4, the weight of the glass substrate 10 is sufficient to provide the pressure between the glass substrate 10 and the patterning roller to impart the desired pattern to the glass. In other embodiments, as shown in FIG. 5, a pressure may be applied by a pressure generator 120 to the top surface 20 of the glass substrate 10 to force the substrate 10 into the patterning roller to impart the pattern. The pressure may be applied by the pressure generator 120 in any suitable manner, including providing a pressure roller (having a generally smooth outer surface) above the glass substrate 10 in a vertically aligned position with the patterning roller or a forced gas (e.g., air) stream acting against the top surface 20 of the glass substrate 10.

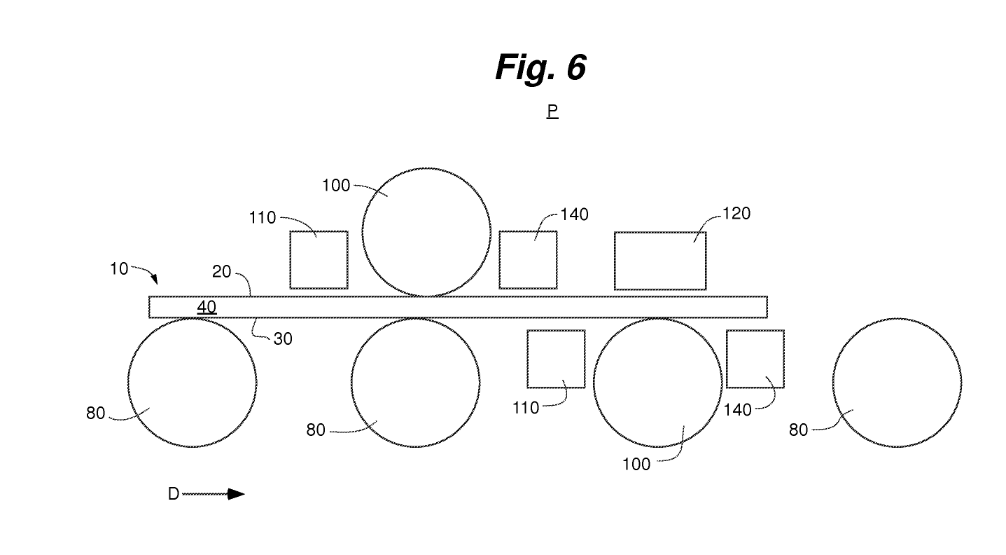

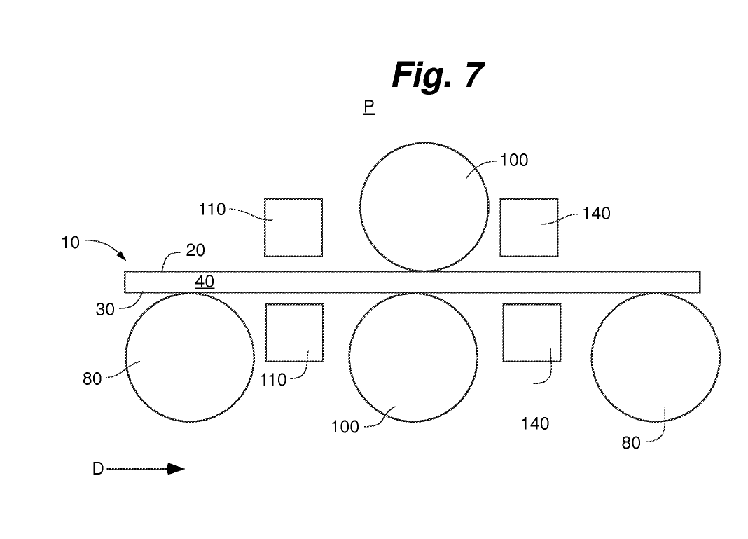

In some embodiments, both the top surface 20 and the bottom surface 30 of the substrate 10 can be patterned in the pattern zone P, either in sequence (as shown in FIG. 6) or in parallel (as shown in FIG. 7). If in sequence, either the top or the bottom surface can be heated with the patterning heat source 110 to a temperature higher than the second temperature and the pattern can be imparted as described above. Then the other of the top or the bottom surface can be heated with another patterning heat source 110 to a temperature higher than the second temperature and the pattern can be imparted as described above. If simultaneous, both the top and the bottom surfaces can be heated with patterning heat sources 110 to a temperature higher than the second temperature and the pattern can be imparted by two patterning rollers 100 in vertical alignment acting on the glass substrate 10. It should be noted that the patterns imparted to the top and bottom surface need not be similar to each other. In some embodiments, the top surface is imparted with a pattern that is different than the pattern that is imparted to the bottom surface.

The amount of heat required to heat the substrate surface to a sufficient degree to impart a desired pattern to either surface 20, 30 of the glass substrate 10 at a given pressure between the patterning roller 100 and the glass substrate 10 can be determined by the following method, using a burner or burner array as an example of a patterning heat source 110. The heat source 90 can be activated to bring the heating zone H to a desired temperature and the conveyance rollers can be activated. A glass substrate 10 can be introduced to the inlet end of the heat-strengthening line and brought to the second temperature as it is conveyed through the heating zone. The burner or burner array in the patterning zone may be lit and the surface of the glass heated further before it contacts the patterning roller 100. If the pattern is not imparted from the patterning roller 100 to the surface, then the fuel rate to the burner or burner array can be increased to increase the temperature of the surface of the glass (or a separate glass substrate 10 following in series) until the pattern is successfully imparted. Independently, the conveyance rollers can be slowed such that a glass substrate 10 conveyed by the conveyance rollers spends more time proximate the burner or burner array. If the burners are set too high, the glass substrate 10 may stick to the patterning roller 100. In such a circumstance, the fuel rate to the burner should be reduced until the pattern is imparted to the glass substrate 10 (or a separate glass substrate 10 following in series) without the glass substrate 10 sticking to the patterning roller 100. Independently, the rotational speed of the conveyance rollers can be increased such that a glass substrate 10 conveyed by the conveyance rollers spends less time proximate the burner or burner array. This method can be iterated as necessary until the desired pattern is successfully being imparted to the glass substrates without the glass substrates sticking to the patterning roller at a given pressure between the glass substrate 10 and the patterning roller. Further, pyrometers can be included at various locations in the heat tempering furnace to monitor temperatures of the glass substrate and rollers at desired locations and, in some embodiments, transmit readings to a control system to automatically adjust the gas flow rate to the burner or burner assembly and/or the line speed to obtain a desired pattern on the glass substrate.

In some embodiments, as shown in FIG. 2, the patterned glass substrate 10 is cooled in a quenching zone Q with a cooler 130 located downstream of the patterning zone to heat-strengthen the patterned planar glass substrate 10. Generally, the cooling is rapid to develop compressive stress in the surfaces 20, 30, both patterned and unpatterned, if any, of the glass substrate 10 so as to heat-strengthen the glass substrate. In some embodiments, the glass is heat-strengthened by developing compressive stress in the outer surfaces of between about 1,000 pounds per square inch (psi) and about 20,000 psi. In certain embodiments, the compressive stress in the outer surfaces is between about 3,500 psi and about 7,500 psi. Such glass can be certified as “Heat-Strengthened Glass” under various applicable national and international standards. In other embodiments, the compressive stress in the outer surfaces is above about 10,000 psi (e.g., between about 10,000 psi and about 20,000 psi). Such glass can be certified as “Tempered Glass” under various applicable national and international standards. In general, the compressive forces will reside in each surface of the planar glass substrate and inwards about 20% towards the center of the substrate, and tensile forces will reside in about 60% of the thickness of the substrate, extending 30% in each direction from the center of the substrate.

The patterned glass may be cooled by any suitable cooling source. In some embodiments, the cooler 130 includes a gas (e.g., air) stream in contact with the planar glass substrate 10 (e.g., with one or both of its surfaces) to cool the substrate in the quenching zone. Suitable examples include pressure blowers, turbo pressure blowers, industrial exhausters, controllable pitch fans, etc. Further, sources of compressed gas may be provided to create forced drafts around the glass. Conventional tempering blowers and fans can optionally be filtered so as not to contaminate the glass. Radiant cooling can also be used, such as water cooling coils or the like. A water mist system may also be used (e.g., a series of nozzles may be provided to spray water on the glass). Water columns may also be used (e.g., one or more slotted water delivery pipes, tubes, or other conduits may be used). After sufficient cooling to heat-strengthen the patterned glass, the patterned heat-strengthened planar glass substrate 10 is discharged from the discharge end 70 of the heat-strengthening line, where it may be further processed (e.g., coated) or packed for shipping.

In certain embodiments, the temperature of the glass substrate at any part of its thickness does not fall below (e.g., is maintained above) the second temperature as it is conveyed through the heat-strengthening line after the patterning zone until it reaches the quenching zone. Some embodiments also include the step of further heating the patterned planar glass substrate 10 in a second heating zone, which is located downstream of the patterning zone and upstream of the quenching zone, to maintain the second temperature throughout the thickness of the glass substrate. The second heat zone can include additional heat source(s) 90. In some embodiments, one or more heat sources 90 can also be included in the patterning zone to help heat or maintain the temperature of the glass substrate near the second temperature.

In some embodiments, as shown in FIGS. 3-7, the patterned surface or surfaces 20, 30 is cooled with a patterning cooler 140 located in the patterning zone immediately after the pattern is imparted downstream of the patterning roller 100. Such a patterning cooler 140 is useful to bring the temperature of the patterned surface down to or near the second temperature. The patterning cooler can include any device useful for cooling the surface. In some embodiments, the patterning cooler 140 includes a liquid cooling system disposed near (above and/or below) the patterned surface or surfaces. The liquid cooling system can have a liquid conduit with liquid flowing therein to provide radiant cooling to the planar glass substrate 10. In other embodiments, the patterning cooler including a cool gas stream (e.g., air) directed at the at least one patterned surface.

If both surfaces 20, 30 of the glass substrate 10 are patterned, one or both surfaces can be cooled. As shown in FIG. 6, if the surfaces are patterned in series, the first surface to be patterned can be cooled before or after heat is applied to the other surface before the other surface contacts the patterning roller 100. If the surfaces are patterned simultaneously, the surfaces can also be cooled simultaneously downstream of the patterning rollers as shown in FIG. 7.

In some embodiments, the method includes introducing a series of separate and distinct (e.g., spaced-apart) planar glass substrates 10 through the heat-strengthening line. In such embodiments, a series of discrete planar glass substrates, with a gap separating each planar substrate, are introduced into the inlet end and conveyed through the heat-strengthening line, patterned and heat-strengthened as described herein, and discharged from the discharge end of the heat-strengthening line. Unlike patterning a continuous hot glass ribbon immediately downstream of a furnace used to melt the glass forming ingredients, in the present embodiments the glass substrate is patterned after it has been cut, thereby reducing at least some of the cutting steps performed after the glass is patterned.

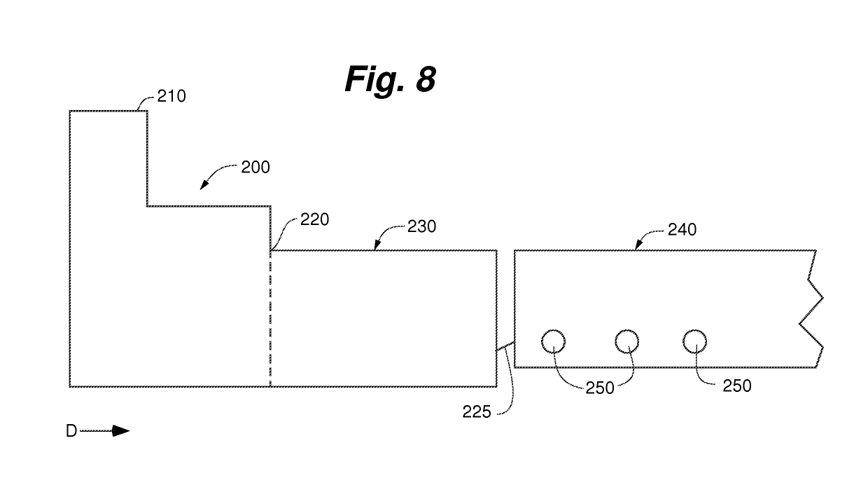

Any type of planar glass may be heat-strengthened and patterned in the heat-strengthening line, such as sheet glass, fusion glass, or float glass. As shown in FIG. 8, in some embodiments the glass to be patterned and heat-strengthened in the heat-strengthening line is float glass made on a float glass line. Referring to FIG. 8, a float glass line includes a glass melting furnace 200 having a series of burners. The furnace includes a charging end 210 where the glass-making materials (sometimes referred to as “batch”) are introduced to the furnace. The furnace also includes a molten glass discharge end 220 where the molten glass (sometimes referred to as the glass ribbon) is expelled from the furnace to a float section 230, usually a bed of molten tin downstream of the furnace. The glass ribbon 225 is continuously withdrawn from the float section 230 to an annealing lehr 240 where it is conveyed on annealing conveyance rollers 250 until annealed. The annealed glass is then cut and packaged as desired. The direction of travel of the glass-making ingredients and glass ribbon through the furnace through the annealing lehr is shown by arrow D.

Annealing is a process of slowly cooling glass to relieve internal stress after it is formed to enhance its durability. In the annealing process, the glass is heated until the temperature reaches a stress-relief point, that is, the annealing temperature (also called annealing point). At this temperature, the glass has a viscosity at which it is still too hard to deform, but is soft enough for the stresses to relax. The glass is then allowed to heat-soak until its temperature is even throughout its thickness. The time necessary for this step varies depending on the type of glass and its maximum thickness. The glass is then slowly cooled at a predetermined rate until its temperature is below the strain point. In annealed glass, the compressive stress at the surfaces is generally between about 100 and 400 psi.

Embodiments of the invention also include methods of making patterned heat-strengthened glass from annealed glass that was produced by a float glass process. In some embodiments, the method includes the step of introducing glass forming ingredients, as described above, into the furnace 200 and melting the glass-forming ingredients in the furnace, delivering the resulting glass ribbon into a float section 230, annealing the glass ribbon in an annealing lehr, and then (optionally after cutting the glass ribbon into a plurality of glass sheets and/or transporting the glass from the float plant to a heat-strengthening facility remote from the float plant) heat-strengthening and patterning the resulting annealed glass in a heat-strengthening line as described above. Accordingly, in some embodiments, the planar glass substrate 10 introduced into the inlet end of a heat-strengthening furnace is annealed glass (e.g., annealed float glass). In general, the glass ribbon is at ambient temperature and cut into a series of discrete substrates after the annealing lehr and before being delivered to the heat-strengthening line.

Examples of glass in accordance with embodiments of the invention include soda-lime silica-based glass. In certain example embodiments of the invention, the glass includes, by oxide percent: SiO₂ 67-75%, Na₂O 10-20%, CaO 5-15%, and/or Al₂O₃ 0.4%-1.3%, as well as other components. Embodiments of the invention also include glass that is a low-iron glass; low-iron glass is generally high solar transmission glass that is particularly useful in glass-based solar cells. In such embodiments, the glass has total iron (expressed as Fe₂O₃) of 0.002 to 0.11% (e.g., about 0.008 to about 0.11%, e.g., about 0.01 to about 0.09%).

The patterned heat-strengthened glass made in accordance with embodiments of the invention provides excellent solar transmittance. Transmittance numbers provided herein are estimated for a glass thickness of 3.2 millimeters. In some embodiments, the total solar transmittance of patterned heat-strengthened glass made in accordance with embodiments of the invention is more than about 87%. In other embodiments, total solar transmittance is more than about 88%. In yet other embodiments, total solar transmittance is more than about 89%. In some embodiments, total solar transmittance is between about 89% and about 90%. In other embodiments, the total solar transmittance is greater than 91% (e.g., up to and including 92%). In some embodiments, the visible transmittance of patterned heat-strengthened glass made in accordance with embodiments of the invention is more than about 88%. In other embodiments, visible transmittance is more than about 89%. In yet other embodiments, visible transmittance is more than about 90%. In some embodiments, visible transmittance is between about 90% and about 91.5%. The UV transmittance of patterned heat-strengthened glass made in accordance with some embodiments of the invention is more than about 85%. In other embodiments, UV transmittance is more than about 86%. In yet other embodiments, UV transmittance is more than about 87%. In some embodiments, total solar transmittance is between about 87% and about 88%.

Patterned heat-strengthened glass in accordance with embodiments of the invention is useful for many applications, including residential glass (e.g., obscured glass for bathroom windows), architectural glass, shower doors, furniture (e.g., table tops), and for inclusion in a glass-based solar cell, such as a photovoltaic glazing assembly.

The heat-strengthening and patterning of embodiments of the glass described above allows it to be particularly useful for glass-based solar cell applications. Photovoltaic devices are used to convert solar radiation into electrical energy. The heat-strengthened patterned glass described herein can be used for any type of photovoltaic device having a glass substrate, including crystalline silicon devices. In some embodiments, solar energy will pass through a glass substrate included in such an assembly to reach a photovoltaic coating disposed on the inside of the assembly. Materials used in the photovoltaic coating may include copper-indium selenide, copper indium/gallium diselenide, gallium arsenide, organic semiconductors (such as polymers and small-molecule compounds like polyphenylene vinylene, copper phthalocyanine, and carbon fullerenes), tin and fluorine doped tin, and thin film silicon. Suitable film thicknesses, layer arrangements, and deposition techniques are well known for such layers. The coating can include one or more of the following: a sodium ion barrier layer, a transparent conductive oxide (TCO) layer, and a buffer layer. Suitable materials, film thicknesses, layer arrangements, and deposition techniques are well known for such layers. These layers may be deposited over a patterned surface of a heat-strengthened glass substrate or over a smooth surface opposite the patterned surface.

Accordingly, embodiments of the invention include methods of making patterned heat-strengthened glass, a glass processing apparatus for heat-strengthening and patterning glass, and the resulting patterned heat-strengthened glasses. More particularly, embodiments of the invention include patterned heat-strengthened glasses where the pattern is imparted in a heat-strengthening line. In such embodiments, glass substrates preferably are heated to a temperature suitable for heat-strengthening, patterned, and then cooled to form a patterned heat-strengthened glass substrate (preferably on a single heat-strengthening line). Such embodiments allow discrete glass substrates to be efficiently patterned, and eliminate some cutting steps after patterning. Such patterned heat-strengthened glass substrates are particularly useful, for example, in glass-based solar cells. Accordingly, because of the reduced waste associated with the systems and methods described herein compared to traditional patterning techniques, solar cells may be provided more cost-effectively which, in turn, may lead to quicker widespread adoption of such cells.

While some preferred embodiments of the invention have been described, it should be understood that various changes, adaptations and modifications may be made therein without departing from the spirit of the invention.

What is claimed is:

1. A method of heat strengthening and patterning glass, comprising:
introducing a planar glass substrate having a thickness into an inlet end of a heat-strengthening line, the planar glass substrate having a first temperature;
conveying the planar glass substrate from the inlet end of the heat-strengthening line towards a discharge end of the heat-strengthening line on a conveyance system;
heating the planar glass substrate in a first heating zone located between the inlet end and the discharge end of the heat-strengthening line to a second temperature of between about 550 degrees Celsius and about 650 degrees Celsius throughout its thickness;
patterning at least one surface of the planar glass substrate in a patterning zone located downstream of the first heating zone, the patterning comprising heating the at least one surface of the planar glass substrate to a temperature greater than the second temperature and contacting the heated at least one surface of the planar glass substrate with a patterning roller;
cooling the patterned planar glass substrate in a quenching zone located downstream of the patterning zone so as to heat-strengthen the patterned planar glass substrate; and
discharging the patterned heat-strengthened planar glass substrate from the discharge end of the heat-strengthening line.

2. The method of claim 1, wherein a top surface of the planar glass substrate is patterned in the patterning zone.

3. The method of claim 2, wherein the conveyance system includes a series of conveyance rollers and the patterning zone including at least one conveyance roller for conveying the planar glass substrate, and the patterning roller is positioned above a top surface of the planar glass substrate and vertically aligned with the conveyance roller.

4. The method of claim 1, wherein a bottom surface of the planar glass substrate is patterned in the patterning zone.

5. The method of claim 4, wherein the patterning roller is positioned beneath a bottom surface of the planar glass substrate as it is conveyed through the patterning zone.

6. The method of claim 1, wherein both a top surface and a bottom surface of the planar glass substrate are patterned in the patterning zone.

7. The method of claim 6, wherein the top surface is imparted with a pattern that is different than a pattern that is imparted to the bottom surface.

8. The method of claim 1, wherein the at least one surface of the planar glass substrate is heated to the temperature greater than the second temperature by at least one burner located upstream of the patterning roller and directed at the at least one surface.

9. The method of claim 1, wherein the at least one surface is heated to a temperature of between about 750 degrees Celsius and about 900 degrees Celsius in the patterning zone.

10. The method of claim 1, further including cooling the at least one surface in the patterning zone downstream of the patterning roller.

11. The method of claim 10, wherein the at least one surface is cooled with a liquid cooling system disposed above the planar glass substrate in the patterning zone, the liquid cooling system having a liquid conduit with liquid flowing therein to provide radiant cooling to the planar glass substrate.

12. The method of claim 10, wherein the at least one surface is cooled with a cool gas stream directed at the at least one surface.

13. The method of claim 1, wherein the planar glass substrate is heated to the second temperature via radiant heat from at least one electric heating element disposed in the heating zone.

14. The method of claim 1, wherein the planar glass substrate is cooled in the quenching zone via contact with a gas stream in contact with the planar glass substrate.

15. The method of claim 1, wherein a series of discrete planar glass substrates are introduced into the inlet end.

16. The method of claim 1, wherein the planar glass substrate introduced into an inlet end of a heat-strengthening furnace is annealed glass.

17. The method of claim 1, wherein the planar glass substrate is soda-lime glass that was produced in a float glass line including a float bath.

18. The method of claim 1, wherein the thickness of the planar glass substrate is between 1 millimeter and 15 millimeters.

19. The method of claim 1, wherein the pattern is shaped to increase light transmission of the planar glass substrate.

20. The method of claim 1, wherein the temperature of the planar glass substrate at any part of its thickness does not fall below the second temperature as it is conveyed through the heat-strengthening line after the patterning zone until it reaches the quenching zone.

21. The method of claim 1, further including heating the patterned planar glass substrate in a second heating zone located downstream of the patterning zone and upstream of the quenching zone to maintain the second temperature throughout the thickness of the planar glass substrate.

22. The method of claim 1, wherein the first temperature is an ambient temperature.

23. The method of claim 1, wherein the first temperature is less than about 100 degrees Celsius, and the planar glass substrate is at the first temperature throughout its thickness.

24. The method of claim 1, wherein the conveyance system includes a series of driven conveyance rollers.

25. The method of claim 1, wherein surfaces of the planar glass substrate have a compressive stress of at least 1,000 psi after the substrate is discharged from the heat-strengthening line.

26. The method of claim 1, wherein surfaces of the planar glass substrate have a compressive stress of at least 10,000 psi after the substrate is discharged from the heat-strengthening line.

27. The method of claim 1, wherein the planar glass substrate is tempered as a result of the cooling in the quenching zone.

28. The method of claim 1, wherein the conveying the planar glass substrate involves moving it continuously, without any substantial stops, from when it enters the inlet end of the tempering line until when it reaches the quenching zone of the tempering line.

29. The method of claim 1, wherein at least substantially of said conveying the planar glass substrate involves moving it along tops of spaced-apart conveyance rollers.

30. The method of claim 1, wherein the resulting patterned heat-strengthened glass has outer surfaces stressed in compression and an inner body stressed in tension.

31. A glass processing apparatus adapted to both heat-strengthen and pattern a plurality of moving glass sheets, the apparatus comprising a heat-strengthening line having an inlet end and a glass conveyor system configured to convey the glass sheets along the heat-strengthening line, the heat-strengthening line including a first heating zone located between the inlet end and a discharge end of the tempering line, the first heating zone comprising means for heating a glass sheet conveyed therethrough to a desired temperature of between about 550 degrees Celsius and about 650 degrees Celsius, the apparatus including a patterning zone located downstream of the first heating zone, the patterning zone comprising a patterning roller configured to bear against respective surfaces of glass sheets conveyed through the patterning zone, and a quenching zone located downstream of the patterning zone, the quenching zone comprising means for rapidly cooling hot glass sheets.
